(19) United States
(12) Patent Application Publication
(10) Pub. No.: US 2005/0052885 A1
(43) Pub. Date: Mar. 10, 2005

(54) Structure of LED decoration lighting set

(75) Inventor: Han Wen Wu, Kowloon (CN)

Correspondence Address: ALIX YALE & RISTAS LLP, 750 MAIN STREET, SUITE 1400, HARTFORD, CT, 06103, US

(73) Assignee: Amazing International Enterprise Limited

(21) Appl. No.: 10/655,211

(22) Filed: Sep. 4, 2003

(51) Int. Cl. F21S 4/00; F21V 7/04; A63J 17/00; A47G 35/00

(52) U.S. Cl. 362/565

(57) ABSTRACT

This invention relates to the functional features of lighting devices, particularly, the structure of refractors of an LED decoration lighting set. It is composed of a decorative part made of transparent materials and an illuminant. The illuminant is activated by an external power supply and is incorporated into the decorative part. Bubbles are found uniformly and densely in the decorative part in a region which intersects the light emitted from the illuminant. The bubbles enable the decorative part to become a combination of a spherical concave and convex lens. When the light emitted from the light-emitting part is transmitted to the decorative part, a large amount of non-sequential diversion, conversion, refraction and reflection will take place to significantly change the original transmission path of the light beam. This solves the problem of the small viewing angle of a traditional LED decoration lighting set.

### TECHNICAL FIELD

This invention relates to the functional features of lighting devices, particularly, the structure of refractors for an LED decoration lighting set.

### BACKGROUND OF THE INVENTION

Nowadays, lighting adds variety to the life of people, such as a home-used dim light bulb, a flashlight for a toy, and a festive decoration lighting set. One of the important criteria for decoration lighting is that the emitted light should be spread uniformly and can be viewed from all surfaces; hence, the entire contour of the decoration lighting set can be viewed maximizing the efficiency of the lighting.

At the moment, an LED, as a light source, has been widely applied in the field of a decoration lighting set. FIG. 1 shows a kind of common hemispherical LED. It is composed of an LED die 1, a terminal pin 2, a wire 3 and an epoxy (resin) 4. A casting of transparent epoxy (resin) forms the protective cap and acts as lens. Light emitted from LED die 1 converges on the hemispherical tip. Luminous intensity is higher when viewing from the tip and it decreases rapidly when viewing from the sides; therefore, the viewing angle of the LED is small and is mainly used for front view application. The set-back of the LED as a light source, namely, the narrow viewing angle and the uneven diffusion of light beam on the surface of the decoration lighting set, not only affects the aesthetic delicateness, but also restricts the application of an LED.

A prior art “wide viewing angle LED decoration lighting set” (CN: 9924823) provided a solution for this defect. As shown in FIG. 2, the technical solution of this prior art is composed of two devices: the first device is an encapsulated LED serving as a light source; the appearance of the second device can be modified accordingly and there is a room for the first device to be fit-in flexibly in order to disperse the light beam emitted from the first device to all directions. The materials that can be used for the second device include PC, PS, Acrylic or ABS which are transparent materials. A light diffusion agent, glass powder and fluorescein can be added as additional substances. Light diffusion agent is used for diverging the light beam; hence widening the lighting angle of the first device. The LED die also changes the color of the second device providing a greater range of choices for the customers. Although the viewing angle of this “wide viewing angle LED” prior art is widened through the lighting decoration, the viewing angle is not satisfactory. Moreover, the distance between the LED and all the surfaces of second device has to be fixed at an identical length, and the shape of the second device is limited to a spherical shape. The longer the distance between the surface of the second device and the LED, the longer the transmission path of light. Dispersion takes place several times inside the set, wherein the light beam is getting dimmer, narrowing the viewing angle; the shorter the distance between the surface of the second device and the LED, the brighter the light beam. As a result, the light beam projected on the surface is uneven. This largely restricts the shape of the device as it is difficult to overcome the problem brought by the dispersion effect of the light beam. Moreover, as a light diffusion agent is used, this undermines the transmission of the light beam.

### SUMMARY OF THE INVENTION

An object of this invention is to provide a lighting set which can address the prior art deficiencies by providing a wide viewing angle, uniform brightness and an efficient structure.

In one technical solution of this invention, bubbles are uniformly and densely found in the decorative part which intersects the light emitted from the light source. The volume of all the bubbles takes up 30% of the total volume of the decorative part. The size of bubble can be varied immensely, i.e. several times. There should be at least three layers of bubbles along the transmission path of the light.

The decorative part of this invention mentioned above can be made from epoxy, PS, PE, PC, acrylic, ABS or glass. The decorative part can be cast in advance with a groove for the illuminant to be fit-in. The illuminant and the decorative part can be cast at the same time as one whole set. The illuminant mentioned can be an LED, a miniature bulb or a quartz lamp.

The bubbles densely found in the decorative part enable it to become a combination of a spherical concave and convex lens. When the light emitted from the illuminant transmits in the decorative part, a large amount of non-sequential diversion, conversion, refraction and reflection take place and this entirely changes the original transmission path of the light beam. When the light exits from the surface of the decorative part, diffusion of light takes place, i.e. when the light is emitted from the illuminant, efficient diffusion, refraction, conversion is in progress, maximizing the entire lighting effect of the decorative part. Light diffusion agent, glass powder and fluorescein can be added to improve light emission.

The advantages of this invention are as follows:

1. Material is saved. The product is lighter. As there are plenty of bubbles in the decorative part, the volume taken up by the bubbles and the groove for the illuminant can help save up to 10% or more of the materials used. The weight decreases.

2. Highly transparent. Very few or no light diffusion agent which may undermine the transmission of light is added.

3. The light is highly diffusive and color mixing is possible. When the light transmits in the decorative part, the original transmission path is entirely modified by the densely structured bubbles. This solves the problem of a narrow viewing angle.

4. There is balance of the shape of the set and the diffusion effect. The diffusion of light beam mainly depends on the densely structured bubbles serving as concave and convex lens but not the light diffusion agent. The volume of the bubble is 10 times or even thousand times larger than light diffusion agent. The influence of the length of light transmission on the degree of diffusion has been largely reduced. The decorative part can be in any shape.

### BRIEF DESCRIPTION OF THE DRAWINGS

FIG. 1: Structure of a prior art LED,

FIG. 2: Structure of a prior art “wide viewing angle LED decoration lighting set”,

FIG. 3: Structure of this invention,

FIG. 4: Structure of the first embodiment of this invention,

FIG. 5: Structure of the second embodiment of this invention,

FIG. 6: Structure of the third embodiment of this invention,

FIG. 7: Structure of the fourth embodiment of this invention,

FIG. 8: Structure of the fifth embodiment of this invention,

FIG. 9: Structure of the sixth embodiment of this invention,

FIG. 10: Structure of the seventh embodiment of this invention,

FIG. 11: Structure of the eighth embodiment of this invention,

FIG. 12: Structure of the ninth embodiment of this invention,

FIG. 13: Structure of the tenth embodiment of this invention.

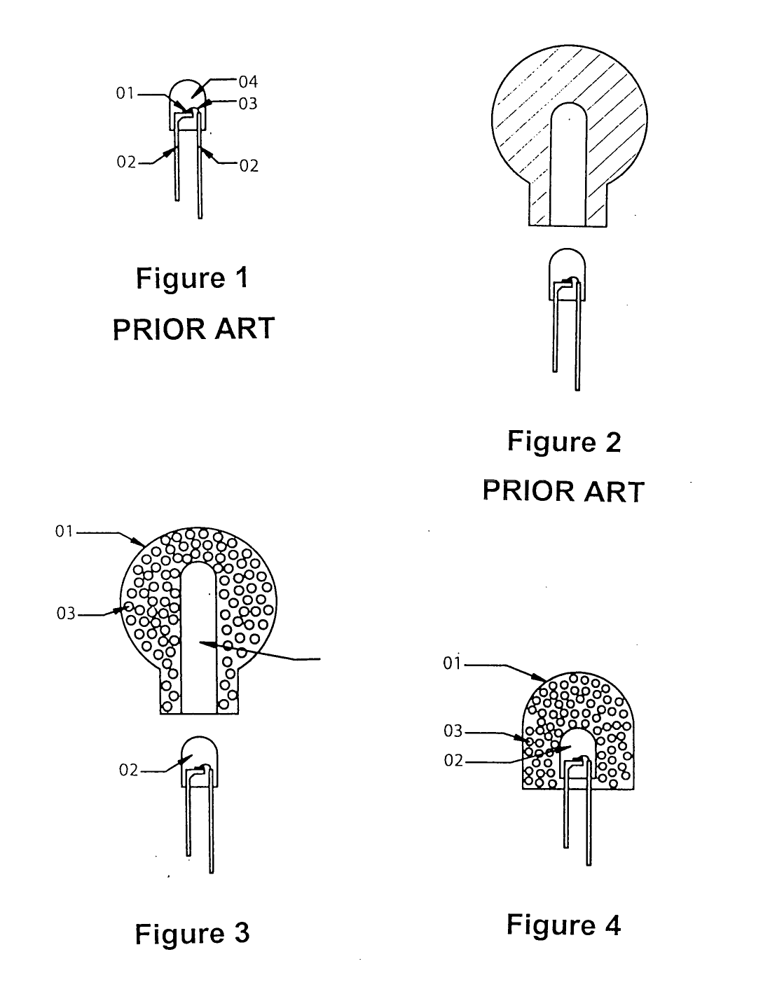

### DESCRIPTION OF PREFERRED EMBODIMENTS

As shown in FIGS. 3-13, this invention includes a decorative part 1 made from transparent materials and an illuminant 2. The illuminant 2 is activated by an external power supply and is fixed into the decorative part 1. The decorative part 1 can be made from epoxy, PS, PE, PC, acrylic, ABS or glass. There are bubbles 3 in the decorative part 1. The bubbles 3 are uniformly and densely found in the decorative part 1 where it intersects the light beam emitted from the illuminant 2. The total volume of bubbles 3 takes up 30% or more of the total volume of the decorative part 1. The volume of bubbles 3 can be varied immensely, i.e. several times. There are at least three layers of bubbles 3 along the transmission path of the light beam.

The decorative part 1 can be made through running casting or injection. For running casting, air injection, stirring or both of them can be applied to produce plenty of bubbles 3 in the transparent materials with high velocity. Through the control of technological parameters, such as air flux, stirring speed and the viscidity of the transparent materials, the size and the amount of bubbles 3 can be varied. Then, such materials are cast into a shape required for the decorative part 1 with bubbles 3 inside. According to the installation requirement of the illuminant 2, both the illuminant 2 and the decorative part 1 can be cast as one whole set; or a groove 11 can be made in advance for the flexible fitting of the illuminant 2. For injection, vesicant is added in the highly transparent materials and then such materials are injected into a shape required for the decorative part 1 with bubbles 3 inside. According to the installation requirement of the illuminant 2, both the illuminant 2 and the decorative part 1 can be cast as one whole set; or a groove 11 can be made in advance for the flexible fitting of the illuminant 2.

The bubbles 3 densely found in the decorative part 1 enable the decorative part 1 to become a combination of a spherical concave and convex lens. When the light emitted from the illuminant 2 transmits in the decorative part 1, a large amount of non-sequential diversion, conversion, refraction and reflection take place and this entirely changes the original transmission path of the light beam. When the light exits from the surface of the decorative part 1, diffusion of light takes place, i.e. when the light is emitted from the illuminant 2, efficient diffusion, refraction, conversion is in progress, maximizing the entire lighting effect of the decorative part 1. Light diffusion agent, glass powder and fluorescein can be added to improve light emission.

In FIG. 4, the illuminant 2 is a LED. The encapsulated LED 2 is cast into the decorative part 1 with bubbles. Two of them bond together to form one entire part. The material used for the decorative part 1 is transparent resin. There are at least three layers of bubbles 3 along the transmission path of the light beam in the decorative part 1. The total volume of bubbles 3 takes up 30% or more of the total volume of the decorative part 1. The volume of bubbles 3 can be varied immensely, i.e. several times. The decorative part is cast as a hemisphere. Cylindrical, tower, oval and various shapes can be applied. The first embodiment of this invention described here is to provide a lighting set with a wide lighting angle.

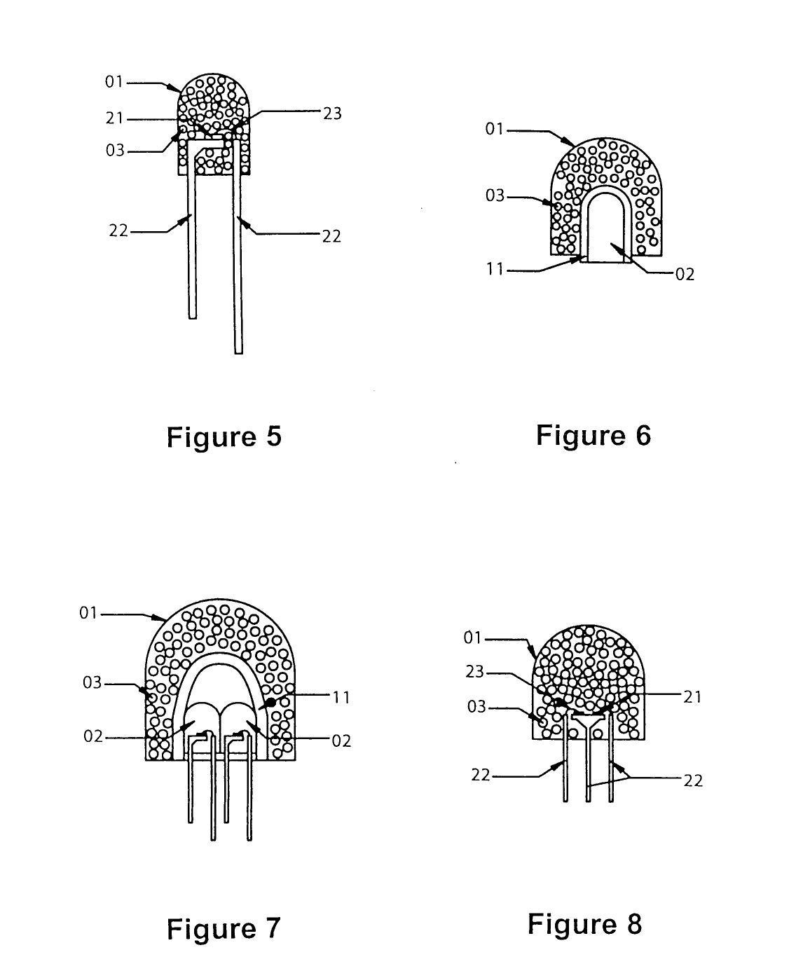

In FIG. 5, the transparent resin of a traditional LED is replaced by the decorative part 1 with bubbles 3 inside. The highly transparent material used for the decorative part 1 is transparent resin. The decorative part 1 with bubbles 3 inside is cast as the outer shell of the common LED. LED die 21, terminal pins 22 and wire 23 can be made together with the decorative part 1 as one whole set. The decorative part 1 shown in the figure is hemispherical. It can be cylindrical, rectangular, tower, oval and triangular. The second embodiment of this invention described here is to provide a LED of common size with high diffusive luminous intensity.

In FIG. 6, the decorative part 1 with bubbles 3 inside is made as a pocket. The third embodiment of this invention described here is hemispherical. It can be rounded, rectangular, tower, oval, triangular and in various shapes. In the pocket of the decorative part 1, there is a groove 11 for the illuminant 2 to be inserted into. The shape of the groove 11 matches the contour of the illuminant 2 so that the illuminant 2 can be inserted in flexibly. One LED 2 can be inserted in the decorative part 1. As shown in FIG. 6, more than one LED 2 can be inserted.

As shown in FIG. 7, the fourth embodiment of this invention, LEDs 2 with different colors can be inserted in the decorative part 1 to create a different combination of colors. The size of groove 11 depends on the size of the combination of the LED 2, so that the light emitted from LED 2 can be directly and uniformly transmitted to the combination of bubbles in the decorative part 1 maximizing the luminous intensity. This fourth embodiment of this invention is mainly for providing a small decoration lighting set with light diffusion and flexible fitting through the combination of the decorative part 1 with bubbles 3 inside and the LED 2.

In FIG. 8, the fifth embodiment of this invention, a small decoration lighting set with high efficiency is made from the decorative part 1 with bubbles 3 inside, die 21, terminal pins 22 and wire 23.

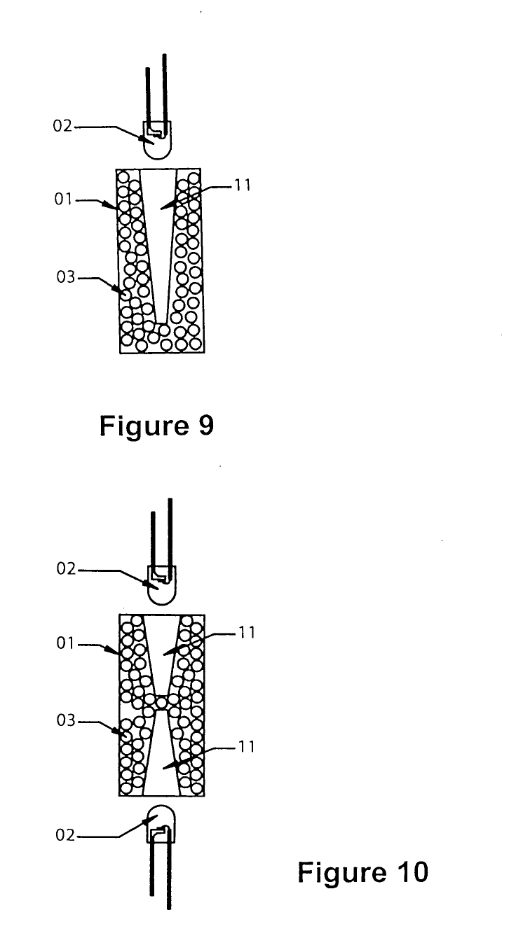

In FIGS. 9 & 10, the illuminant 2 is represented by an LED. The decorative part 1 with bubbles 3 inside is made as a column. The embodiment here is a cylinder. But it can be rectangular, triangular, hexagonal or polygonal. The LED 2 is inserted in one or two ends of the column. The light beam emitted from the LED 2 diffuses in the column glowing the whole column. The sixth or seventh embodiment of this invention described here is to provide a lighting tube in column shape, with high efficiency, made from the decorative part 1 with bubbles 3 inside and the LED 2.

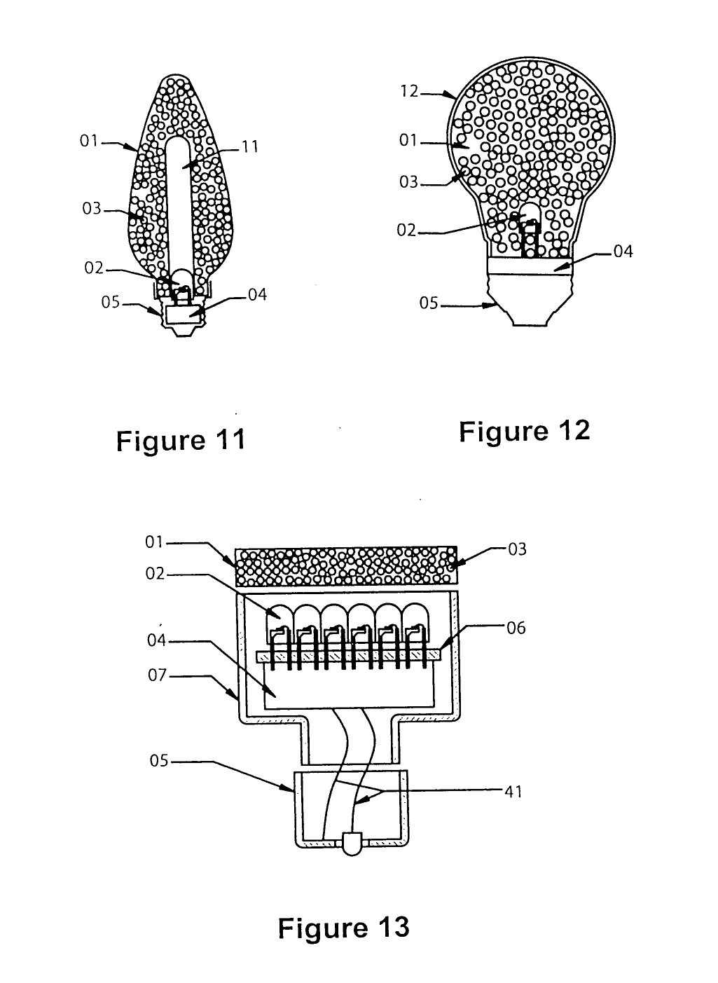

In FIG. 11, the eighth embodiment of this invention, the LED 2 is connected to the driving device 4. Common lamp-base 5 is connected to driving device 4 and forms part of the outer case. The light emitting terminal of the LED 2 is surrounded by the decorative part 1 with bubbles 3 inside. The decorative part 1 is in the shape of a common light bulb and forms part of the outer case. The common lamp-base 5 can be an Edison base or bayonet base for installation. The function of the driving device 4 is to turn A/C power to the voltage and current needed to activate the LED 2. A light emitting groove 11 enables the light beam emitted from the LED 2 to be focused directly on the tip of the decorative part 1 maximizing the luminous intensity. This eighth embodiment of this invention is to provide a common light bulb with high efficiency through the combination of the decorative part 1 with bubbles 3 inside and the LED 2.

FIG. 12 is the ninth embodiment of this invention. The difference between FIG. 11 and FIG. 12 is that there is a transparent outer case 12 outside the decorative part 1. The transparent outer case 12 can be made of transparent materials or glass. The shape of the transparent outer case 12 is identical to common light bulb. It can also be in any other shape. The decorative part 1 with bubbles inside 3 made from running casting is inserted in the transparent outer case 1. This ninth embodiment of this invention is to provide a highly efficient common light bulb through the combination of the decorative part 1 with an outer case and the LED 2.

In FIG. 13, the tenth embodiment of this invention, several LEDs 2 are installed on the circuit board 6. The circuit board 6 is connected to the driving device 4. Through the electrical wire 41, the driving device 4 is connected to the common lamp-base 5. The common lamp-base 5 and the outer case 7 form the entire protective case. The decorative part 1 with bubbles 3 inside can be lens-shaped, cylinder, sphere or hemisphere and is installed in front of the LEDs 2. The light beam of these LEDs can be diffused mutually and the different colors of the LEDs 2 can be shown in cycle. This tenth embodiment of this invention is to provide a lighting set with strong light source through the combination of the decorative part 1 with bubbles 3 inside and several LEDs.

1. A structure for a decoration lighting set comprising:
a decorative part made of transparent material; and
an illuminant activatable by an external power supply and received by the decorative part,
wherein said decorative part is configured with uniformly and densely spaced bubbles in a region where light emitted from the illuminant intersects the decorative part.

2. The structure of claim 1, wherein the total volume of all bubbles occupies 30% or more of the total volume of the decorative part.

3. The structure of claim 1, wherein there are at least three layers of bubbles alongside the transmission path of the light beam in the decorative part.

4. The structure of claim 1, wherein the decorative part is made from a material selected from the group consisting of epoxy, PS, PE, PC acrylic, ABS or glass.

5. The structure of claim 1, wherein the illuminant is selected from the group consisting of an LED, a miniature bulb or a halogen lamp.

6. The structure of claim 1, wherein the decorative part has a groove for fixably receiving the illuminant.
